(19) United States
(12) Patent Application Publication
(10) Pub. No.: US 2014/0029730 A1
(43) Pub. Date: Jan. 30, 2014

(54) TENSIONED FLAT ELECTRON EMITTER TAPE

(71) Applicant: Agilent Technologies, Inc., Loveland, CO (US)

(72) Inventor: Damian Kucharczyk, Wroclaw (PL)

(21) Appl. No.: 13/928,311

(22) Filed: Jun. 26, 2013

(30) Foreign Application Priority Data
Jul. 26, 2012 (EP) EP12178138

(51) Int. Cl. H01J 35/06

(52) U.S. Cl. CPC H01J 35/06
USPC 378/125; 378/136

(57) ABSTRACT

An electron beam emitter for generating an electron beam to be directed towards an anode of an X-ray tube for generating an X-ray beam, wherein the electron beam emitter comprises an electrically conductive tape, made of material capable of emission of electrons, configured to be supplied with electric energy for emitting the electron beam, and a support arrangement configured for mounting the tape under permanent tension.

### BACKGROUND

The present invention relates to an electron beam emitter, an X-ray tube, an X-ray source and a method of generating an electron beam.

An X-ray tube is a vacuum tube that produces X-rays. X-rays are part of the electromagnetic spectrum with wavelengths shorter than ultraviolet light. X-ray tubes are used in many fields such as X-ray crystallography, medical devices, airport luggage scanners, and for industrial inspection.

An X-ray tube comprises a cathode, which emits electrons into vacuum and an anode to collect the electrons, thus establishing an electron beam. A high voltage power source is connected across cathode and anode to accelerate the electrons. Electrons from the cathode collide with the anode material so that a part of the energy generated is emitted as X-rays. The X-ray beam may then be shaped by passing an X-ray optics and subsequently a collimator. The remaining part of the energy causes the anode to be heated. The heat is removed from the anode, typically by radiative or conductive cooling and might involve the use of cooling water, flowing behind or inside the anode.

In a rotating anode tube, the anode can be rotated, for instance by electromagnetic induction from a series of stator windings outside the evacuated tube. The purpose of rotating the anode is to cause the electron beam to collide with the anode at a range of positions along a circular track instead of one stationary position, which thus spreads out the heating and allows a greater electron beam power to be used, thus generating a higher power of X-rays. However, the anode requires complex cooling to obtain high X-ray flux. Moreover, the rotation of the anode requires highly complex bearings and sealings to maintain the vacuum.

U.S. Pat. No. 8,121,258 discloses a device to deliver an X-ray beam at energies greater than 4 keV, comprising an X-ray source comprising an electron gun adapted to generate a continuous beam of electrons onto a target region of an anode for X-ray emission by the anode, wherein said anode forms a solid of revolution of a diameter between 100 and 250 millimetres, and is fixedly connected to a motor shaft so that it is driven in rotation by a rotation system, and the electron gun and the anode are arranged in a vacuum chamber, said chamber comprising an exit window to transmit an X-ray beam emitted by the anode outside of the chamber, conditioning means to condition the X-ray beam emitted through the exit window, the conditioning means comprising an X-ray optic adapted to condition the X-ray beam emitted with a two-dimensional optic effect, wherein the electron gun is designed to emit an electron beam of a power less than 400 watts, and comprises means to focus said electron beam on the target region in a substantially elongate shape defined by a small dimension and a large dimension, wherein the small dimension is comprised between 10 and 30 micrometres and the large dimension is 3 to 20 times greater than the small dimension, the rotating anode comprises an emission cooling system to evacuate, by radiation, part of the energy transmitted by the electron beam to the anode, the rotation system comprises a motor with magnetic bearings designed to set the rotating anode in rotation at a speed of more than 20,000 rpm, and the exit window is arranged so as to transmit an X-ray beam emitted by the anode so that the X-ray beam emitted towards the conditioning means is defined by a substantially point-size focal spot of dimension substantially corresponding to the small dimension of the shape of the target region.

There are limitations with regard to the obtainable X-ray flux when using conventional filaments for an electron beam emitter of an X-ray tube.

### SUMMARY

It is an object of the invention to provide an X-ray tube which allows to obtain a high X-ray flux. The object is solved by the independent claims. Further embodiments are shown by the dependent claims.

According to an exemplary embodiment of the present invention, an electron beam emitter for generating an electron beam to be directed towards an anode of an X-ray tube for generating an X-ray beam is provided, wherein the electron beam emitter comprises an electrically conductive tape, which may be made of a material capable of easy emission of electrons (such as Tungsten), configured to be supplied with electric energy for emitting the electron beam, and a support arrangement configured for mounting the tape under permanent tension.

According to another exemplary embodiment, an X-ray tube for generating an X-ray beam is provided, wherein the X-ray tube comprises an electron beam emitter having the above mentioned features for generating an electron beam, and an anode arranged and configured to generate X-rays upon exposure to the generated electron beam.

According to still another exemplary embodiment, an X-ray source is provided which comprises an X-ray tube having the above mentioned features, an X-ray optic for collecting and focussing X-rays generated in the X-ray tube, and an X-ray beam conditioner for conditioning the X-rays after collecting and focussing them by the X-ray optic.

According to yet another exemplary embodiment, a method of generating an electron beam to be directed towards an anode of an X-ray tube for generating an X-ray beam is provided, wherein the method comprises supplying an electrically conductive tape with electric energy for emitting the electron beam, and mounting the tape under permanent tension during the generation of the electron beam.

In the context of this application, the term “electrically conductive tape” may particularly denote a strip or foil or other flat structure which is made from a material capable of conducting electric current. Particularly, this electrically conductive tape should be made of a material which is capable of emission of electrons when an electric signal is applied along the electrically conductive tape. Suitable materials are Tungsten, Molybdenum, etc. Such an electrically conductive tape may be a foil which is so thin that it can be bent, rolled or folded.

In the context of this application, the term “mounting the tape under permanent tension” may particularly denote that the tape is mounted, for instance clamped, so as to remain in a flat planar shape even in the event of an at least partial loss of the intrinsic tension of the tape. For instance when being heated by a current applied to the tape for triggering electron emission from the tape, thermal and/or electric and/or chemical and/or aging effects may have the tendency to change shape of the tape over time. By providing a mechanism of mounting the tape under permanent tension, the required tension force for maintaining the shape of the tape invariantly flat and planar is continuously delivered to the correspondingly mounted tape regardless of a change of its intrinsic properties.

According to an exemplary embodiment of the invention, an electron beam emitter is provided which generates an electron beam when an electric signal is applied to an electrically conductive tape. By using an electrically conductive tape, i.e. a basically planar structure, rather then a conventional filament, usually a coil of wire, for emitting the electrons, a particularly efficient electron emission occurs into a desired direction, i.e. perpendicular to a main surface of such a flat and for instance rectangularly shaped tape and towards an anode. A coil is commonly used as a filament since its form stabilizes the shape of the emitter against the effects of deformation due to heating, aging, etc. However, the coil emits electrons in all directions and so is less effective than the tape in emitting electrons only or predominantly in the direction in which they are useful (i.e. in the direction towards the anode). The tape is narrow in order to make a small active area but it is very efficient in generating electrons which emit in the desired direction. It is easier to make a narrow tape (e.g. laser cut from a sheet of material) than to make a narrow/small coil of wire. The coil would have to be small in order to generate a narrow electron beam.

According to an exemplary embodiment of the invention, the electrically conductive tape is advantageously mounted under permanent tension by a support arrangement. This means that the support arrangement is configured for ensuring that, during the entire electron beam emission process, the shape and orientation of the tape maintains constant or basically constant. This may be an issue since a tape may have the tendency to bend or deform due to its thin configuration. In other words, the support arrangement holds and keeps the tape under tension or mechanical strain so that it is prevented from changing its shape in the mounted configuration. In this context, the maintenance of the tension in a permanent way means that the support arrangement may have a provision to maintain the tension even if the physical properties of the tape change over time. For instance, by heating the tape with the supply current for triggering the electron emission, the tape may slightly change its shape or dimensions due to thermal expansion and other effects. The support arrangement may ensure that the permanent tension is maintained even in the presence of such a change of the physical properties of the tape. This may be performed by clamping or chucking the tape at least over a part of its extension so that at least the section of the tape which actually emits electrons is maintained in a strained flat shape

Next, further exemplary embodiments of the electron beam emitter will be explained. However, these embodiments also apply to the X-ray tube, the X-ray source and the method of generating an electron beam.

In an embodiment, the support arrangement is configured for delivering additional tension to the tape upon loss of intrinsic tension of the tape. Thus, in case of ageing effects, temperature effects or the like which have an impact on the tension of the tape, the support arrangement may deliver additional tension so as to maintain the shape and the tension of the tape even in the case of such changes. A spring or any other source of tension (for instance using an electric force) may be biased or pre-tensioned for this purpose.

In an embodiment, the support arrangement comprises a first fastening structure and a second fastening structure, wherein the tape is clamped under tension between the first fastening structure and the second fastening structure. For instance, a first portion (such as a first end portion) of the tape may be connected to the first fastening structure and a second portion (such as a second end portion)) of the tape may be connected to the second fastening structure, so that the central portion of the tape between the first fastening structure and the second fastening structure is under tension and serves for emitting the electrons.

In an embodiment, the first fastening structure and the second fastening structure protrude over (or its upper ends are spaced with regard to) a base of the support arrangement. This allows to spatially separate the electrically conductive tape to which a voltage is applied, from the base of the support arrangement. The two fastening structures are electrically isolated from each other to allow a current to be passed between them only through the tape, which is mounted between them. They are also electrically isolated from a focusing cap and a cover (both described below in further detail) since they are electrically biased (for instance −100V) relative to the tape. However, the whole emitter assembly (i.e. two posts, tape, focusing cap, etc) is biased to high voltage relative to the anode.

In an embodiment, the first fastening structure is a first post and the second fastening structure is a second post. Such posts may be oblong plates with half circular ends. Such posts may alternatively be cylindrical, particularly circular cylindrical structures. The posts may extend in parallel from the base of the support arrangement.

In an embodiment, a first end portion of the tape is guided, particularly bent, over the first fastening structure, particularly over a curved surface portion of the first fastening structure, and a second end portion of the tape is guided, particularly bent, over the second fastening structure, particularly over a curved surface portion of the second fastening structure, so that a central portion of the tape is bridged under tension between the first fastening structure and the second fastening structure. Such bending of the tape results in a structure which is similar to that of a conveyor belt being mounted on rollers. The central portion of the tape is then free of any contact with the fastening structures and can freely emit electrons without disturbing influences. Furthermore, the bending of end portions of the tape over the fastening structures ensures that the central portion of the tape is an unalterable flat planar structure capable of emitting the electron beam.

In an embodiment, the tape has a length in a direction extending between the first fastening structure and the second fastening structure, has a width and has a thickness both extending in a respective direction perpendicular to the direction extending between the first fastening structure and the second fastening structure. The length and the width may be both larger than the thickness, particularly may be at least about three times of the thickness, more particularly at least about ten times of the thickness. Therefore, a very thin structure can be provided as the tape. The tape or its central portion may for instance be configured as a thin film which may have a rectangular shape. This allows to concentrate the large majority of the emitted electrons onto the main surfaces of the tape, i.e. the two surfaces of the tape having the by far largest areas.

In an embodiment, the length is larger than the width, particularly is at least five times of the width, more particularly at least ten times of the width. Hence, an oblong structure can be used as the tape.

In an embodiment, the support arrangement comprises a tensioning element, particularly a spring (for instance a helical spring, a flat spring, a disc spring), configured for applying a tensioning force, particularly a biasing spring force, to the tape for maintaining the tape under permanent tension. The spring may be configured as a compression spring or as a pull spring. A pre-tensioned spring is a proper choice for the tensioning element because it allows to deliver additional clamping force in case that ageing effects, temperature effects or the like reduce the intrinsic tensioning of the electrically conductive tape or simply change its shape.

In an embodiment, the tensioning element is arranged to exert the tensioning force to at least one of the first fastening structure and the second fastening structure so as to mechanically bias (or tension) tape mounting sections of the first fastening structure and the second fastening structure outwardly. This ensures that the electron emission characteristic of the tape even stay constant under such circumstances. Lever effects can be advantageously used when the tensioning element exerts a tensioning force to one section of a pivotable fastening structure to pivot it so that an opposing section of the pivotable fastening structure at which the tape is mounted applied a resulting force to the tape to keep it under tension.

In an embodiment, the tape comprises a central rectangular strip portion between two laterally widened end portions of the tape, wherein the laterally widened end portions are particularly recessed (i.e. provided with a blind hole) or perforated (i.e. provided with a through hole) so as to be receivable in fastening structures of the support structure. Such a configuration is particularly advantageous because it allows to mount the end portions of the tape in a mechanically stable way and to simultaneously increase the ohmic resistance of the tape at the central rectangular strip portion being narrowed. Thus, the actual part of the tape at which the electron emission predominantly takes place, i.e. the central rectangular strip portion, can be brought to a specifically high temperature (by current application) due to locally pronounced ohmic losses which is advantageous in terms of electron emission efficiency.

In an embodiment, the central rectangular strip portion has an aspect ratio (i.e. a ratio between length and width) of at least five, particularly of at least ten. The thickness may again be much smaller than the width.

In an embodiment, the tape consists of a rectangular strip. Hence, a rectangular strip can be formed from a tungsten foil or the like which allows to have a geometrically simple and symmetric structure.

In an embodiment, the tape is a meander-shaped strip, particularly meander-shaped with a circular outer envelope. A meander-shaped strip has the advantage of a long electric path along which emission of the electrons takes place, wherein the ohmic resistance of the meander-shaped strip is additionally very large. The circular envelope ensures that the electron beam is emitted basically with a circular cross-section.

In an embodiment, the support arrangement comprises a rigid support ring which supports the tape at least along a part of its perimeter. Since a meander-shaped strip may have the tendency of changing its shape over time or with varying temperature of electric current, a support ring may stabilize the structure and may ensure that it remains under tension all the time.

In an embodiment, the electron beam emitter comprises an electric energy supply unit configured for supplying the tape with the electric energy for emitting the electron beam. Such an electric energy supply unit may be a current source for applying a sufficiently large current between ends of the tape so as to trigger electron emission.

In an embodiment, the electric energy supply unit is configured for supplying the tape with the electric energy by applying an electric supply current, particularly by applying an electric supply current in a range between about 1 A and about 5 A, between opposing ends of (particularly along) the tape connected to the first fastening structure and the second fastening structure both being configured as electrically conductive fastening structures.

In an embodiment, the support arrangement is integrally formed, particularly from a single piece of metal. By manufacturing the support arrangement from a single piece of metal from which specific parts are removed for instance by milling, a compact, stable and mechanically robust support arrangement may be provided. For instance, a spring can be formed in the support arrangement by removing material sections so that the spring structure remains as a part of the processed metal part.

In an embodiment, the electron beam emitter comprises a focusing cap configured for at least partially covering the support arrangement and the tape and having an aperture shaped to define a shape of the electron beam propagating from the tape through the aperture. Thus, the focusing cap may perform beam shaping very close to the emission position of the electron beam from the tape, rendering the generated electron beam highly definable with regard to shape and size.

In an embodiment, the support arrangement is configured for mounting the tape so as to keep a central portion of the tape flat and oriented parallel to a planar end surface, including the aperture, of the focusing cap to create the best emitting area for the electron beam at a main surface rather than at a side edge of the tape. It is advantageous to keep the central portion of the tape flat and oriented parallel to the focusing cap to create the best emitting area for the electron beam from the surface of width W (and not the surface of thickness T (see FIG. 2)). For instance, the central portion of the tape which may be laterally narrowed with regard to the mounting end portions may be arranged in parallel to a slit of the focusing cap.

In an embodiment, the aperture is an oblong slit, particularly an oblong slit extending to be aligned with a largest extension of the tape. The opening is slit-like but the electron beam is not slit-like since only the central part of the narrowed part of the tape can get hot enough to emit electrons. The electron beam cross section is not circular but it is also not slit-like. It is oval, being longer in the direction along the slit.

In an embodiment, the electron beam emitter comprises a voltage source configured for bringing the focusing cap to a negative potential as compared to the tape, particularly to apply a voltage therebetween in a range between about 50 V and about 1 kV. This provision forces the electron beam emitted from the tape to be focused through the slit in the focusing cap, thereby allowing to further precisely shape the electron beam.

In an embodiment, the electron beam emitter comprises a cover configured for at least partially covering the focusing cap and having an opening shaped to define a shape of the electron beam propagating through the aperture and through the opening. The cover with its opening allows to further refine the beam-shaping capability of the electron beam emitter. The cover may for instance have a circular opening.

In an embodiment, the voltage source is configured for bringing the cover to the same negative potential as the focusing cap. Cover and focusing cap may for instance be directly electrically coupled to one another. This allows for a simple and compact construction, since a single voltage source may be used for applying a voltage to both the cover and the focusing cap.

In an embodiment, the cover and the focusing cap are integrally formed, for instance made from one integral piece of material.

Next, further exemplary embodiments of the X-ray tube will be explained. However, these embodiments also apply to the electron beam emitter, the X-ray source and the method of generating an electron beam.

In an embodiment, a high voltage is applied between the tape and the anode which causes the electron beam, emitted by the tape, to be formed and accelerated.

In an embodiment, the X-ray tube comprises an electron beam manipulator configured for manipulating a shape of the electron beam in a path between the electrically conductive tape and the anode. When using a tape emitter producing for instance an oval or oblong electron beam, it is advantageous to focus the electron beam to a small size in order to make a narrow X-ray beam which will be able to enter the X-ray optic and thereafter make a narrow focused X-ray beam onto the sample. This task is fulfilled by an electron beam manipulator. Such electron beam manipulation or beam-shaping is advantageous because it allows for a rastering of the electron beam on the anode (which may be a rotating anode or a stationary anode) or any other target. First of all such a manipulation may allow to properly distribute the heat load over a larger portion of the anode. Furthermore, this makes it possible to control size and position of the X-ray beam so that any desired X-ray beam profile may be adjusted. Furthermore, taking this measure allows X-ray beam shaping prior to the X-ray generation, i.e. by manipulating the electronic beam rather than the X-ray beam. By this early stage beam-shaping and beam positioning, it is possible to obtain a less complex aligning on the optic level, i.e. after generation of the X-ray beam. Such an aligning may be performed in an X-ray optic and/or collimator which are located downstream of the anode in the direction of X-ray beam propagation.

In a conventional approach, there is a fixed point of X-ray generation, and the optic is aligned using complex mechanical adjustments to properly orient it with respect to the incoming X-rays. In an embodiment of the invention, the position of X-ray generation is adjusted by adjusting the position of the electron beam, and thus the alignment needed on the optic is simplified. Thus, the incoming X-rays position is adjusted relative to the optic, rather than vice versa. A simplified mechanical adjustment of the optic may still be possible or necessary.

In an embodiment, the electron beam manipulator comprises an electrostatic electron beam manipulator, a magnetostatic electron beam manipulator and/or an electrodynamic electron beam manipulator. An electrostatic electron beam manipulator uses a static electric field which can nevertheless be adjustable for manipulating the properties of the electron beam. A magnetostatic electron beam manipulator uses a static magnetic field for applying a Lorentz force to the electron beam to thereby manipulate it. An electrodynamic electron beam manipulator uses electric and/or magnetic fields which may change over time for manipulating the electron beam. Such components may be used individually or in any desired combination.

In an embodiment, the electron beam manipulator is configured for manipulating the electron beam by focusing the electron beam onto a target section of the anode, positioning the electron beam towards a target section of the anode, dissipating the energy of the electron beam in an event of emergency, and/or swinging the electron beam along a one dimensional or a two-dimensional target trajectory on the anode. For focusing the electron beam onto a target section of the anode, electric and/or magnetic fields may be used for deflecting the electron beam accordingly. Positioning the electron beam towards a target section of the anode may be performed with a same measure. Dissipating beam energy may be performed by directing the electron beam to a position where it does not hit the anode so that no X-ray emission takes place. Swinging the electron beam along one direction or along two directions may be performed with electric and/or magnetic forces as well. Such a swinging may be a pendulum-like swinging, i.e. forcing an electron beam to reciprocate along a linear trajectory. A two-dimensional rastering of an electron beam may involve guiding the electron beam along a trajectory involving two directions.

In an embodiment, the electron beam manipulator comprises an electrostatic focusing unit, particularly two or more spaced annular electrically conductive structures, being shaped and electrically chargable or charged so as to focus (i.e. to reduce spot size of) the electron beam in the path between the electron beam emitter and the anode. It is possible to use two, three or more focusing structures, i.e. an electron gun with multi-stage elements of any desired number. The shape of such electrically conductive structures and/or the electric field applied to such electrically conductive structures may define the electrostatic focusing performance.

In an embodiment, the electron beam manipulator comprises a magnetic focusing unit (particularly an annular coil to which coil a drive current is applicable or applied, optionally having an annular ferrit core) being configured so as to focus the electron beam in the path between the electron beam emitter and the anode. The electron beam may hence by guided through an opening of a ring-like powered coil with an optional ferric core.

In an embodiment, the electron beam manipulator comprises a magnetic deflection unit having a magnetic ring with at least two, particularly at least four, magnetic protrusions extending from the magnetic ring inwardly, wherein each ring is surrounded by a coil being supplyable or supplied with electric current so as to deflect the electron beam in the path between the electron beam emitter and the anode in accordance with the applied electric current. Using two opposing magnetic protrusions, a one-dimensional rastering is possible. Using four such magnetic protrusions, a two-dimensional rastering is possible.

In an embodiment, rastering in one or two dimensions is performed electrostatically. An electrically charged electrode, e.g. a flat plate, can be used to attract or repel an electron beam, depending on the size and polarity of voltage applied to it.

In an embodiment, the X-ray tube has a user interface for enabling a user to control operation of the X-ray tube by control commands, wherein the electron beam manipulator is configured for manipulating the shape and/or a position of the electron beam in accordance with a control command received via the user interface. Such a user interface allows for a user-defined definition of the rastering properties based on a user input received by input elements such as a keypad, buttons, a mouse, etc.

In an embodiment, the X-ray tube has a control unit configured for controlling operation of the X-ray tube by executing predefined control commands, wherein the electron beam manipulator is configured for manipulating the shape and/or a position of the electron beam in accordance with the executed control commands. Such an automatic, for instance software-based, control, may allow a user to program any desired profile with regard to rastering which is then executed automatically by a control unit such as a processor.

In an embodiment, the electron beam emitter is configured for generating an electron beam with an oval, particularly an elliptical, cross section on the anode (in order to spread the heated area on the anode), and wherein the anode is slanted with regard to a propagation direction of the electron beam so as to generate an X-ray beam with a circular (or rounded polygonal) cross section, when viewed along the direction of X-ray beam propagation from the anode towards the optic. The electron-illuminated spot on the anode will emit X-rays in all directions, i.e. all angles, above the anode surface. The majority of these X-rays never leave the steel-walled chamber which surrounds the anode since only those passing through the beryllium window can progress towards the X-ray optic. The slanting angle of the anode surface and the angle between the electron beam and the X-ray beam path towards the X-ray optic may be chosen so that the apparent shape of the X-ray beam cross-section, as viewed in the line of the X-ray beam propagation, is circular or rounded polygonal.

The combination of an oval-shaped electron beam and its slanted impinging on an anode will result in the formation of a basically circular X-ray spot which is advantageous for many applications such as X-ray crystallography. More precisely, the oval beam plus slanting angle plus choice of X-ray beam propagation direction, result in a circular X-ray beam cross-section, which is advantageous. The narrowness of the size of the spot, which is also advantageous if small samples are studied, results from the size of the focused electron beam and the size of the rastered area (i.e. size of the electron-illuminated spot on the anode).

In an embodiment, the X-ray tube comprises an electron acceleration unit configured for applying an acceleration voltage between the electron beam emitter and the anode for accelerating the electron beam. In an embodiment, the electron beam emitter is at a negative potential in a range between about 8 kV and about 100 kV in relation to the anode. Such an electronic acceleration unit may by powered by a high voltage source.

In an embodiment, the anode is a rotatably mounted anode. The manipulation of the beam and the provision of a tape emitter are particularly advantageous for a rotating anode configuration because this is particularly prone to overheating. Rastering of the electron beam may relax the cooling requirements for the rotating anode while at the same time allowing for a high X-ray flux.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates an electron beam emitter tape with a narrowed central electron emission section for an electron beam emitter according to an exemplary embodiment of the invention.

FIG. 2 illustrates a rectangular electron beam emitter tape for an electron beam emitter according to another exemplary embodiment of the invention.

FIG. 3 illustrates an electron beam emitter according to an exemplary embodiment of the invention having a meandrically shaped electrically conductive tape supported by a circumferential support ring.

FIG. 4 illustrates components of an electron beam emitter according to an exemplary embodiment of the invention with a one-piece support arrangement for mounting a tape emitter, a focusing cap and a cover.

FIG. 5 and FIG. 6 show cross-sectional views of an electron beam emitter according to an exemplary embodiment of the invention with (FIG. 6) and without (FIG. 5) a focusing cap and with a tensioning spring for permanently maintaining an electrically conductive tape under tension.

FIG. 7 and FIG. 8 show an electrically conductive tape together with a focusing cap and a cover of an electron beam emitter, and representation of an electron beam in two perpendicular directions according to an exemplary embodiment of the invention.

FIG. 9 shows a cross-sectional view and FIG. 10 shows a three-dimensional view of an X-ray source having an X-ray tube having an electronic beam emitter according to an exemplary embodiment of the invention.

FIG. 11 shows a three-dimensional cross-sectional view and FIG. 12 shows a cross-sectional view of an X-ray tube having an electron beam emitter and an electron beam manipulator according to an exemplary embodiment of the invention.

FIG. 13 shows an X-ray tube with an electron beam manipulator according to an exemplary embodiment of the invention.

The illustration in the drawing is schematically and not to scale.

### DETAILED DESCRIPTION

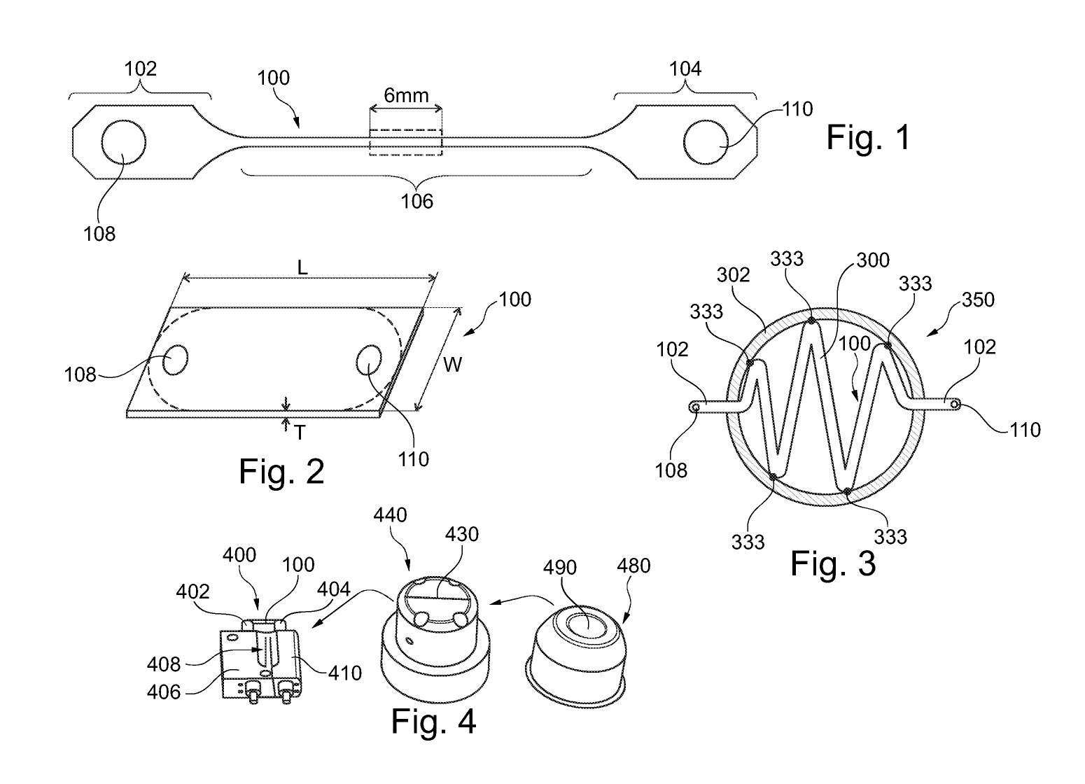

FIG. 1 shows an electrically conductive tape 100 for an electron beam emitter according to an exemplary embodiment of the invention.

The electrically conductive tape 100 is made of Tungsten (more precisely is made by cutting, particularly laser cutting, of a Tungsten foil) and is capable of easy emission of electrons

For emitting an electron beam, the electrically conductive tape 100 has to be supplied with an electric current. As can be taken from FIG. 1, the tape 100 comprises a central rectangular strip portion 106 which is located between two laterally widened end portions 102, 104 of the tape 100. The laterally widened end portions 102, 104 are perforated, see perforations 108, 110, i.e. are provided with through-holes. Alternatively, they can also be recessed, i.e. be provided with a blind hole. Via the perforations 108, 110 (or blind holes), the tape 100 can be mounted at post-like fastening structures (which will be described below) of a support arrangement of the corresponding electron beam emitter for maintaining the tape 100 under permanent tension. When a current of for instance 5 A is applied between the end portions 102, 104, electron emission will predominantly take place in the narrowed oblong central rectangular strip portion 106 because here the local ohmic losses will be the largest in view of the geometry. The reason is that the ohmic resistance is high in the confined central portion 106. Particularly a very central range of about 6 mm of the tape 100 will emit electrons since the material is hottest there due to the greatest distance from the fastening structures, which thermally conduct away the heat from the tape 100.

FIG. 2 shows a rectangular tape 100 for an electron beam emitter according to another exemplary embodiment of the invention.

As can be taken from FIG. 2, the rectangular tape 100 has a length L in a direction extending between a perforation 108 for mounting a first fastening structure and a perforation 110 for mounting a second fastening structure. The rectangular tape 100 has a width W perpendicular to the length L and has a thickness T perpendicular to the length L and the width W. For instance, the length L may be 3 cm, the width W may be 1 cm and the thickness T may be 20 μm.

FIG. 3 shows an electron beam emitter 350 according to an exemplary embodiment of the invention. The electron beam emitter 350 has a meander-shaped electrically conductive tape 300 with a basically circular envelope (compare FIG. 3). A support ring 302 which may be made of an electrically isolating material such as ceramic (which can resist high temperature and is vacuum-compatible) supports the tape 300 at multiple positions 333 to keep it under permanent tension.

FIG. 4 illustrates several components of an electron beam emitter according to an exemplary embodiment of the invention.

An electrically conductive tape 100 is clamped between a first post 402 and a second post 404 as fastening structures of a support arrangement 400. The tape 100 is bent over the top of the posts 402, 404 and screws are inserted through the perforations 108, 110 in the tape 100 and screwed into the posts 402, 404. In order to keep the tape 100 under permanent tension, a spring-like structure or tensioning element 408 which is integrally formed from a metal body or base 406 keeps the tape 100 under tension even if ageing effects, temperature effects or the like change the shape of the tape 100. Thus, the posts 402, 404 in combination with the tensioning element 408 serve as support arrangement 400 configured for mounting the tape 100 under permanent tension. Even upon loss of the intrinsic tension of the tape 100, the tensioning element 408 will deliver additional tension by the mechanical biasing or tensioning of the tensioning element 408. As can be taken from FIG. 4, the posts 402, 404 protrude over the base 406 of the support arrangement 400. It should be said that most parts of the support arrangement 400 (i.e. all components apart from the tape 100 and from electrically insulating ceramic tubes) are integrally formed from a single metal piece which is processed by milling or the like. Although not visible in the figure, the holes in base 406 contain ceramic tubes, and the posts 402 and 404 are inserted inside those tubes so as to be electrically isolated from each other so that a current can be passed along the tape 100.

As can further be taken from FIG. 4, the electron beam emitter further comprises a focusing cap 440 which is configured for covering the support arrangement 400 with the tape 100 mounted thereon. The focusing cap 440 has an aperture 430 shaped as a slit to define a shape of the electron beam which is emitted from the tape 100 and which propagates from the tape 100 through the aperture 430. During operation, the cap 440 is mounted above the support arrangement 400 so as to cover it completely.

Furthermore, a cover 480 forms part of the electron beam emitter, is configured for covering the focusing cap 440 and has a round opening 490 which is shaped to define a shape of the electron beam propagating through the aperture 430 and through the opening 490. Before starting the electron emission, the cover 480 will be mounted over the focusing cap 440 so that the structures 400, 440, 480 together constitute an electron beam emitter according to an exemplary embodiment of the invention.

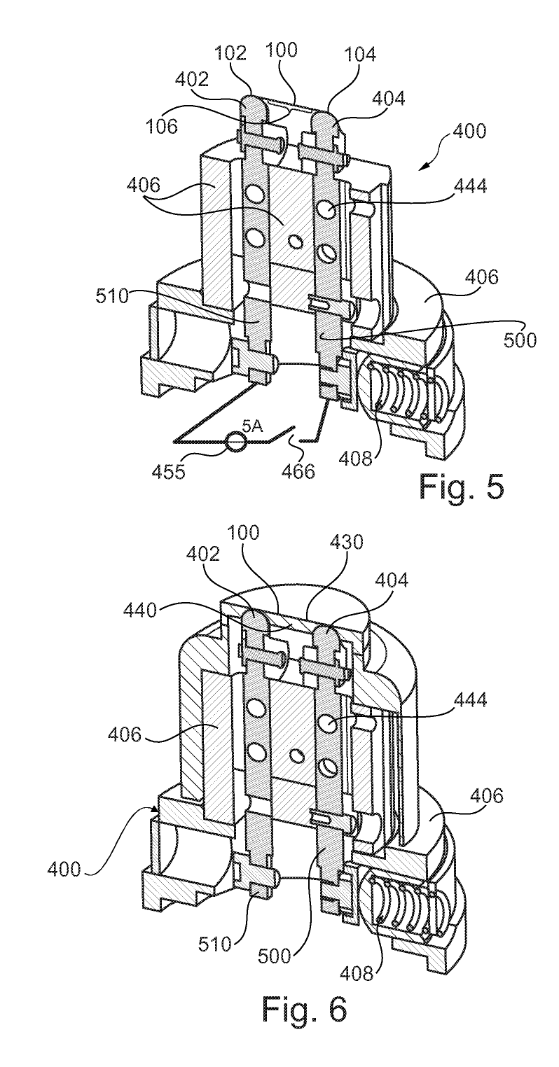

FIG. 5 shows a support arrangement 400 of an electron beam emitter according to an exemplary embodiment of the invention.

FIG. 5 particularly shows that the first end portion 102 of tape 100 is bent over a curved surface portion of first post 402. Accordingly, the second end portion 104 of the tape 100 is bent over a curved surface portion of second post 404 so that the central portion 106 of the tape 100 is bridged under tension between the first post 402 and the second post 404. A tensioning spring 408—here configured as a helical pressure spring, is integrated in base 406 of the support arrangement 400 and applies, by pressing against a beam 500, a force to the second post 404 which is directed outwardly at a top end of second post 404. Therefore, the tape 100 is maintained under tension between the first end portion 102 and the second end portion 104.

FIG. 5 furthermore shows a pivot point 444 of beam 500. The tensioning spring 408 applies a tensioning force to the beam 500 which, consequently, has the tendency to be pivoted around pivot point 444 responsive to the application of the tensioning force. If the tensioning spring 408 is configured as a compression spring or pressure spring applying a pressure to the lower end of beam 500, beam 500 will slightly pivot around pivot point 444 so that the upper end of beam 500 is forced outwardly. In contrast to this, beam 510 is mounted stationary according to FIG. 5, i.e. not pivotable. Consequently, the upper ends of the beams 500, 510 between which the tape 100 is clamped will always actively apply a tension force for tensioning the tape 100 which is therefore strained. In case of loss of intrinsic tension of tape 100 (for instance when being ohmically heated to trigger electron emission), the mechanically biased tensioning spring 408 will deliver in addition tension to tape 100 and can therefore ensure that even in such a scenario, the tape 100 remains under tension during the entire process of electron emission and hence X-ray generation.

For triggering electron emission by tape 100, a switch 466 is closed to apply an electric current from current source 455 to metallic beams 500, 510 and from there to the tape 100.

FIG. 6 shows the same configuration as FIG. 5, however with the focusing cap 440 mounted above the support arrangement 400 and the tape 100.

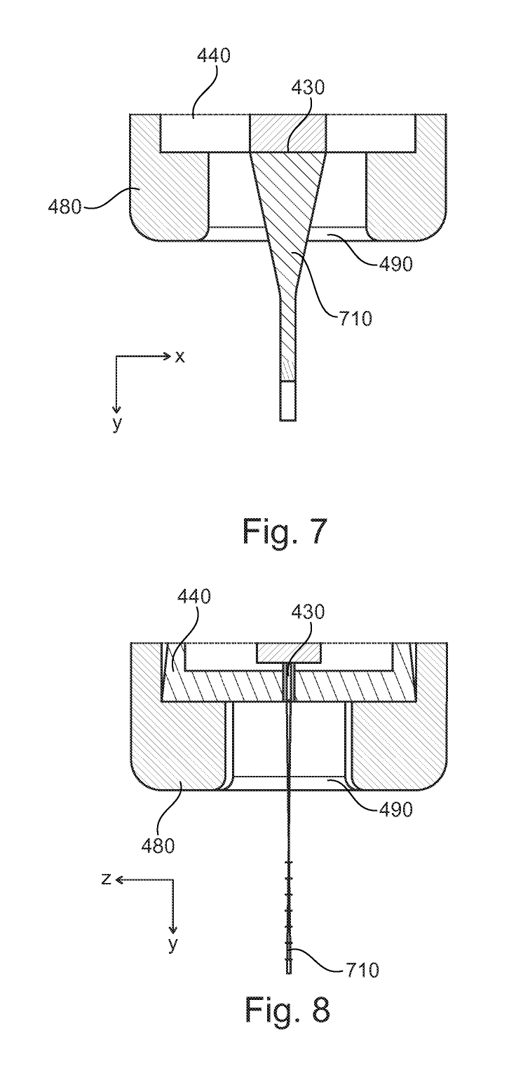

FIG. 7 shows an enlarged cross-sectional view in an xy-plane of the focusing cap 440 and the cover 480 mounted thereon, and particularly shows the shape of the electron beam 710 generated by beam-shaping the electron beam 710 emitted from the tape 100 by the focusing cap 440 and the cover 480.

FIG. 8 shows the same illustration as FIG. 7, however in a cross-section along the yz-plane.

In the following, some considerations of the present inventors with regard to the design of electron beam manipulators for electron emitters for X-ray tubes will be explained, based on which exemplary embodiments of the invention have been developed.

In an embodiment, electrons are generated, directed and squeezed into a focused beam. This beam of electrons is directed onto the surface of the anode. A set of orthogonal electrostatic/electromagnetic elements may provide for electron beam direction onto and movement across the surface of the anode. The point at which the electrons impinge on the surface of the anode may be fixed, or preferably precessed across a defined area of the anode surface. The electrostatic/electromagnetic elements allow the electron beam to be actively moved in two perpendicular directions (which may be perpendicular to the propagation direction of the electron beam) and to be swung achieving precession. The anode target can be any material. In an embodiment, the anode is a metal such as copper, molybdenum, silver, chromium or tungsten but it can also be an alloy or potentially non-metallic material. For instance, the anode has a copper substrate for good heat dissipation and one or more of the above list of materials such as molybdenum or silver, etc. exists as a layer deposited onto the copper substrate. The anode surface may comprise one or more than one material, for example concentric rings of differing metals allowing for multi-wavelength models (i.e. the characteristic wavelength of emitted X-rays will depend upon which ring of material the electron beam impinges). The construction of the anode provides for its rotation up to at least 25,000 revolutions per minute and more. In an embodiment, the anode is conical in shape but with a curved surface such that the outer edge is lower than the rotational centre. The electron beam is directed by the electrostatic electromagnetic elements onto the angled surface of the anode as it is rotated. In this way the electron beam does not impinge on a single fixed point on the anode surface but rather is directed onto and impinges over a strip (such as a ring) of anode surface around the rotating anode. In an embodiment, the electron beam is actively and dynamically oscillated over a definable oscillation range. Whilst this oscillation range is definable and variable it can be of fixed range for the duration of an experimental data collection run where the X-ray source is applied. In an embodiment, the electron beam is oscillated in a first direction (but can also be oscillated independently or in combination with a second direction perpendicular to the first direction) such that the electron beam is caused to impinge and raster over a greater surface area (such as a wider strip) around the surface of the rotating anode.

A purpose of this raster or precessing electron beam is twofold. Firstly to spread the heat load generated over a wider area of the anode, thus dissipating the heat more quickly and efficiently and reducing the potential damage to the anode surface. This allows a greater power of an electron beam to be utilized, thus resulting in a higher brilliance of useable X-rays for a respective application. Secondly, the raster action provides for a variable sized and larger useable X-ray beam on the sample position by means of optical projection. This may be software controlled and definable. The electron beam is approximately circular when static on a single fixed point on the anode surface and may produce a circular X-ray beam of for instance approximately twice magnification equivalent size to the electron beam when projected from the angled surface of the anode through the aperture on to the X-ray optic. The X-ray optic may then provide some magnification of the X-ray beam size before it passes through the beam conditioner path to the sample position. By precessing/rastering the electron beam over the anode surface a rounded ended line of X-rays may be projected from the surface of the anode. Since the surface of the anode is angled, the resultant X-ray beam may be an inclined projection with an effective size of an X-ray beam which is several multiples larger in size than that from a single static electron beam. The shape and size of the X-ray beam is thus variable and selectable by adjusting the range of oscillation of the electron beam and thus the range of raster over the surface of the anode.

The projected X-ray beam having been generated from the surface of the anode is roughly perpendicular to the electron beam and is projected through an X-ray transparent aperture into the X-ray optic housing. Within the X-ray optic housing an X-ray optic including, but not limited to multi-layer, polycapillary, mono-capillary, single crystal or any combination of these, is used to collect, focus and condition the X-rays into a useable X-ray beam which may be monochromated (of single wavelength) and collimated (all X-rays aligned in roughly parallel direction) and which are then directed along a beam conditioner to finally exit through an X-ray transparent window to be directed onto the sample position for use in the application.

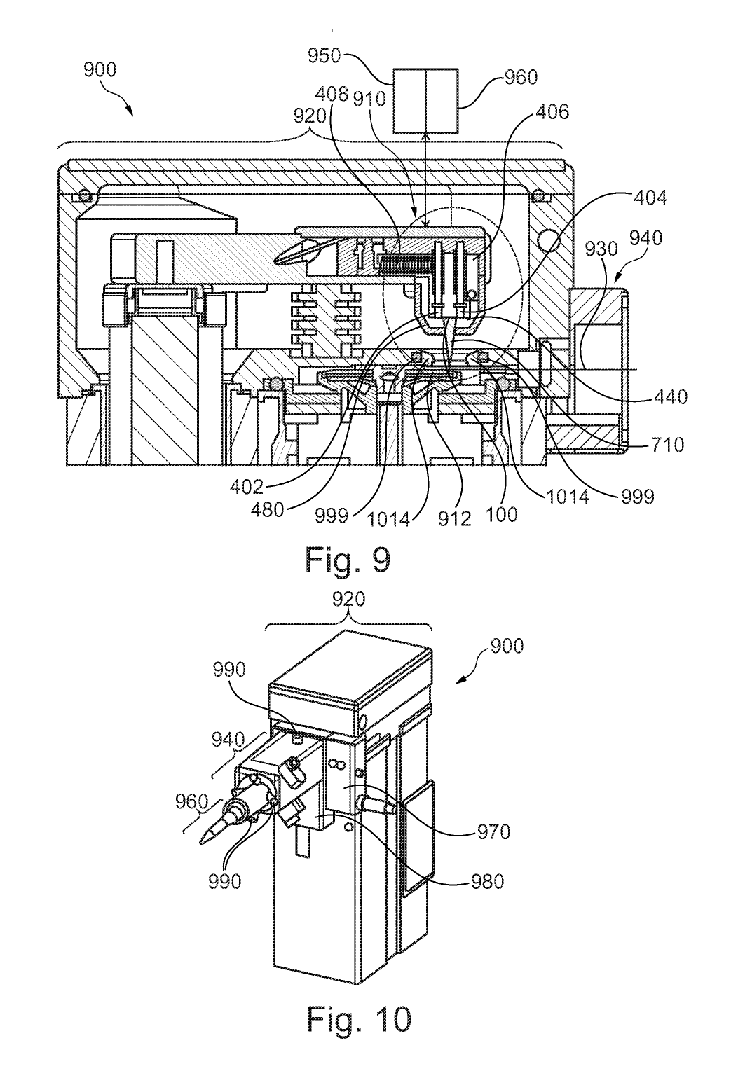

FIG. 9 shows an X-ray source 900 having an X-ray tube 920 and an X-ray optic 940 attached thereto.

The X-ray tube 920 is configured for generating the X-ray beam 930. The X-ray tube 920 comprises an electron beam emitter 910 for generating an electron beam 710, and a copper anode 912 arranged and configured to generate the X-ray beam 930 when being exposed to the generated electron beam 710. The X-ray optic 940 is configured for focusing and collecting the X-ray beam 930 generated in the X-ray tube 920.

The X-ray tube 920 of FIG. 9 furthermore comprises an electron beam manipulator for manipulating a shape of the electron beam 710 in a path between the electrically conductive tape 100 and the anode 912. The electron beam manipulator performs electrostatic focusing by a convex-shaped and electrically charged annulus 480 with a hole through which the electron beam 710 passes. The electrically charged annulus or cover 480 is configured to focus the electron beam 710 onto the anode 912. Furthermore, a magnetic deflection unit 999 deflects the electron beam 710 for performing a one-dimensional rastering of the electron beam 710. The magnetic deflection unit 999 has a magnetic ring with two magnetic protrusions extending from the magnetic ring inwardly and each being surrounded by a powered coil, wherein a signal applied to the coils defines the characteristic of the rastering.

The X-ray tube 920 furthermore has a user interface 950 for enabling a user to control operation of the X-ray tube 920. For this purpose, the user may input control commands via the user interface 950 to the X-ray tube 920. These control commands may be indicative of a manner according to which the shape and/or a position of the electron beam 710 shad be manipulated in accordance with the control command. For instance, a user may define a position at which the electron beam 910 hits the anode 912 to thereby also define a position at which the X-ray beam 930 is emitted. In another embodiment, the user may define a size of the spot of the electron beam 710 impinging on the anode 912, thereby also defining a size of the X-ray beam 930. In yet another exemplary embodiment, a user may define via the user interface 950 a way according to which an electron beam shall be rastered—in a one-dimensional way, i.e. swinging, or in a two-dimensional way, i.e. scanning—over the anode 912. The rastering of the electron beam 710 unambiguously defines a way according to which the X-ray beam 930 is changing shape and/or position over time. Thus, the flexibility of the X-ray tube 920 may be significantly improved by allowing a user-defined manipulation. The user interface 950 may also allow a user to select for instance one of a plurality of prestored control sequences. Each control sequence may be indicative of a corresponding rastering characteristic of the electron beam 710, consequently also of the X-ray beam 930. A control unit or processor 960, for instance a microprocessor or a central processing unit (CPU), may execute the selected control sequence to thereby perform a user-defined rastering.

FIG. 10 shows a three-dimensional view of the X-ray source 900.

The X-ray source 900 has X-ray tube 920 basically having the properties as described above. Furthermore, X-ray optic 940 for collecting and focusing the X-ray beam 930 generated in the X-ray tube 920 is attached to the X-ray tube 920. Beyond this, an X-ray beam conditioner 960 or collimator is provided for conditioning the X-ray beam 930 after collecting and focusing it by the X-ray optic 940.

A safety shutter 970 and a fast shutter 980 are shown as well. Furthermore, adjustment screws 990 are shown by which the X-ray optic 940 can be adjusted relative to the X-ray tube 920, and the X-ray beam conditioner 960 can be adjusted relative to the X-ray optic 940. Particularly, an adjustable mirror (not shown) of the X-ray optic 940 may be aligned by actuating the adjustment screws 990.

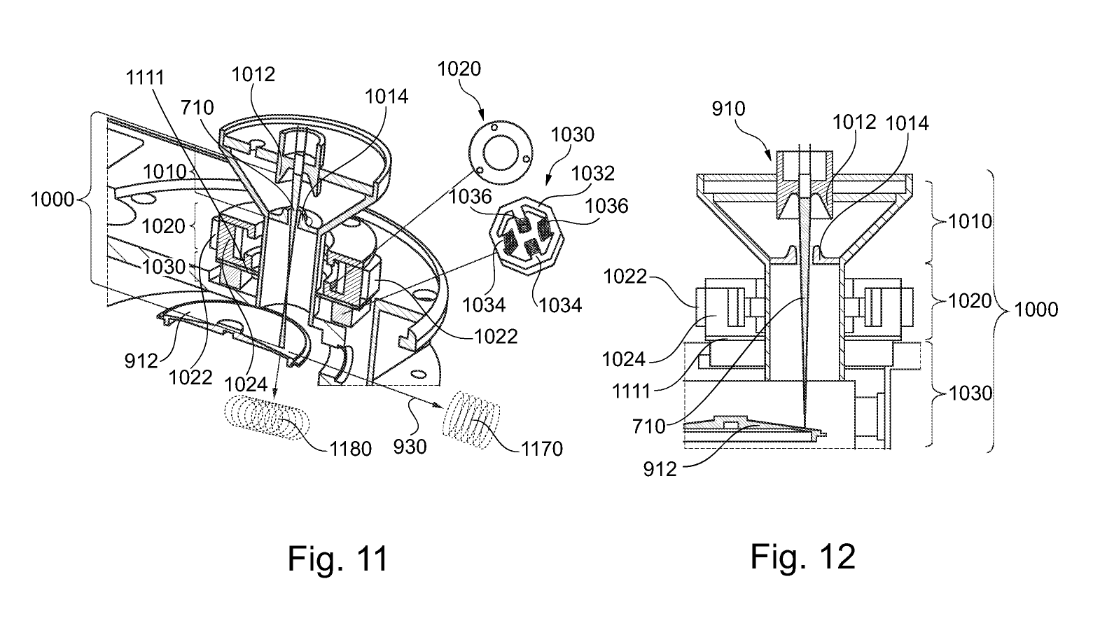

Now referring to the three-dimensional cross-sectional view in FIG. 11 and to the two-dimensional cross-sectional view in FIG. 12, the there shown X-ray tube is capable of precisely defining the characteristics of the X-ray beam 930 emitted and manipulated by an electron beam manipulator 1000 which will be described in the following.

FIG. 11 and FIG. 12 particularly show the electron beam manipulator 1000 which can be implemented in any of the above-described embodiments of electron emitters and which is configured for manipulating a shape of the electron beam 710 in a path between the electron beam emitter 910 (more precisely between the emitter tape 100) and the anode 912. Along this path, the electron beam 710 is accelerated by a high voltage applied between the electron beam emitter 910 and the anode 912. Such a high voltage may for instance be 50 kV. FIG. 11 and FIG. 12 show a combination of an electrostatic focus unit 1010, a magnetic focus unit 1020 and a deflection area 1030 as an electromagnetic manipulator which will be described in the following in further detail. Thus, an electromagnetic system is provided with the electron beam manipulator 1000 which is configured for the deflection and focusing of the electron beam 710 (vibrating).

The electrostatic focus unit 1010 is formed by two cooperating electrically conductive structures 1012 and 1014. As can be taken from FIG. 11 and FIG. 12, the first electrically conductive structure 1012 has the shape of an annulus with a through hole (through which the electron beam 710 passes) delimited by a concave inner surface of the annulus. An outer surface of the electrically conductive structure 1012 is circular cylindrical in shape. The shape of the second electrically conductive structure 1014 is also annular, however with a tapering inner through hole (through which the electron beam 710 passes as well) delimited by a convex inner surface of the annulus. An outer surface of the electrically conductive structure 1014 is concave. The combination of these two electrically conductive structures 1012, 1014 between which a high voltage may be applied, results in an electrostatic focusing of the electron beam 710, as can be taken from FIG. 11 and FIG. 12.

The optional magnetic focus area 1020 is formed by a focusing ring. The focusing ring is constituted by a coil 1022 having a ferrit core 1024, wherein the coil 1022 can be powered so as to generate a magnetic field. This magnetic field exerts a Lorentz force onto the electron beam 710 resulting in a further beam-shaping, i.e. magnetic focusing.

Additionally, the manipulator unit 1000 comprises the electrodynamic electron manipulator or deflection area 1030 which is separated by a diamagnetic separation structure 1111 from the magnetic focus area 1020. The deflection area 1030 comprises a magnetic structure (such as a ferrit structure) having a ring 1032 (such as an octagonal ring) and a plurality of (here: four) magnetic structures 1034 (for instance ferrit cylinders) protruding inwardly from the ring 1032. A coil 1036 is wound around each of the magnetic structures 1034. By applying a current to the coils 1036 surrounding the magnetic structures 1034, a one- or two-dimensional rastering of the electron beam 710 can be performed, thereby deflecting the electron beam 710 in a definable manner. The deflection area 1030 forms a fast quadrupole electromagnetic system for deflection of the electron beam 710.

Reference numeral 1180 shows that the electron beam 710, thanks to the electron beam manipulator 1000, is a point electron beam which is linearly vibrating, i.e. swinging. This results in a corresponding geometry of the X-ray beam 930 which is shown with reference numeral 1170.

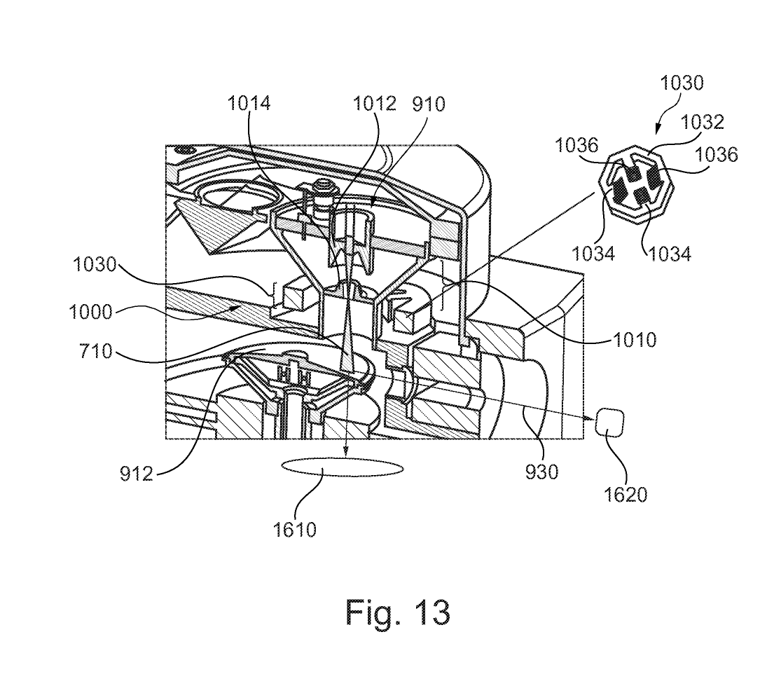

FIG. 13 shows a similar system as FIG. 11 and FIG. 12 and is also an electromagnetic system for the deflection and focusing of the electron beam 710 (stationary). Again, a quadrupole electromagnetic system for focusing of the electron beam 710 is provided. A linearly deformed electron beam is obtained and denoted with reference numeral 1610, and an elliptically/rectangularly deformed X-ray spot is denoted with reference numeral 1620. The magnetic focus area 1020 is omitted in FIG. 13.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. An electron beam emitter for generating an electron beam to be directed towards an anode of an X-ray tube for generating an X-ray beam; the electron beam emitter comprising:
an electrically conductive tape, made of material capable of emission of electrons, configured to be supplied with electric energy for emitting the electron beam;
a support arrangement configured for mounting the tape under permanent tension.

2. The electron beam emitter according to claim 1, wherein the support arrangement comprises a first fastening structure and a second fastening structure, wherein the tape is clamped under tension between the first fastening structure and the second fastening structure.

3. The electron beam emitter according to claim 2, comprising at least one of the following features:
the first fastening structure and the second fastening structure protrude over a base of the support arrangement;
the first fastening structure is a first post and the second fastening structure is a second post;
a first portion of the tape is guided, particularly bent, over the first fastening structure, particularly over a curved surface portion of the first fastening structure, and a second portion of the tape is guided, particularly bent, over the second fastening structure, particularly over a curved surface portion of the second fastening structure, so that a central portion of the tape is bridged under tension between the first fastening structure and the second fastening structure;
the tape has a length (L) in a direction extending between the first fastening structure and the second fastening structure, has a width (W) and has a thickness (T) both extending in a respective direction perpendicularly to the direction extending between the first fastening structure and the second fastening structure, wherein each of the length (L) and the width (W) is larger than the thickness (T), particularly are at least three times of the thickness (T), more particularly at least ten times of the thickness (T);
the tape has a length (L) in a direction extending between the first fastening structure and the second fastening structure, has a width (W) and has a thickness (T) both extending in a respective direction perpendicularly to the direction extending between the first fastening structure and the second fastening structure, wherein each of the length (L) and the width (W) is larger than the thickness (T), particularly are at least three times of the thickness (T), more particularly at least ten times of the thickness (T), wherein the length (L) is larger than the width (W), particularly is at least five times of the width (W), more particularly is at least ten times of the width (W).

4. The electron beam emitter according to claim 1, wherein the support arrangement comprises a tensioning element, particularly a spring, configured for applying a tensioning force, particularly a tensioning spring force, to the tape for maintaining the tape under permanent tension.

5. The electron beam emitter according to claim 2, wherein the tensioning element is arranged to exert the tensioning force to a tension force receiving section of one or both of the first fastening structure and the second fastening structure so as to tension a tape mounting section of one or both of the first fastening structure and the second fastening structure outwardly.

6. The electron beam emitter according to claim 1, comprising a focusing cap configured for at least partially covering the support arrangement and the tape and having an aperture shaped to define a shape of the electron beam propagating from the tape through the aperture.

7. The electron beam emitter according to claim 6, comprising at least one of the following features:
the support arrangement is configured for mounting the tape so as to keep a central portion of the tape flat and oriented parallel to a planar end surface, including the aperture, of the focusing cap to create the best emitting area for the electron beam at a main surface (L, W) rather than at a side edge (T) of the tape;
the aperture is an oblong slit, particularly an oblong slit extending to be aligned along a largest extension of the tape;
the electron beam emitter comprises a voltage source configured for bringing the focusing cap to a negative potential relative to the tape, particularly to apply a negative voltage between the focusing cap and the tape in a range between 50 V and 1 kV;
the electron beam emitter comprises a cover configured for at least partially covering the focusing cap and having an opening shaped to define a shape of the electron beam propagating through the aperture and through the opening;
the electron beam emitter comprises a voltage source configured for bringing the focusing cap to a negative potential relative to the tape, particularly to apply a negative voltage between the focusing cap and the tape in a range between 50 V and 1 kV, and comprises a cover configured for at least partially covering the focusing cap and having an opening shaped to define a shape of the electron beam propagating through the aperture and through the opening, wherein the voltage source is configured for bringing the cover to the same negative potential as the focusing cap.

8. The electron beam emitter according to claim 1, comprising at least one of:
the support arrangement is configured for delivering additional tension to the tape upon loss of intrinsic tension of the tape;
the tape comprises a central rectangular strip portion between two laterally widened end portions of the tape, wherein the laterally widened end portions are particularly recessed or perforated so as to be receivable by fastening structures of the support arrangement;
the tape consists of a rectangular strip;
the electron beam emitter comprises an electric energy supply unit configured for supplying the tape with the electric energy for emitting the electron beam;
the electron beam emitter comprises an electric energy supply unit configured for supplying the tape with the electric energy for emitting the electron beam, wherein the electric energy supply unit is configured for supplying the tape with the electric energy by applying an electric supply current, particularly by applying an electric supply current in a range between 1 A and 5 A, between opposing ends of the tape connected to the first fastening structure and the second fastening structure both being configured as electrically conductive fastening structures;
the support arrangement is integrally formed, particularly integrally formed from a single piece of metal.

9. An X-ray tube for generating an X-ray beam, the X-ray tube comprising:
an electron beam emitter according to any of claims 1 to 8 for generating an electron beam;
an anode arranged and configured to generate X-rays when being exposed to the generated electron beam.

10. The X-ray tube according to claim 9, comprising an electron beam manipulator configured for manipulating a shape of the electron beam in a path between the electrically conductive tape and the anode.

11. The X-ray tube according to claim 10, comprising at least one of the following features:
the electron beam manipulator comprises at least one of the group consisting of an electrostatic electron beam manipulator, a magnetostatic electron beam manipulator and an electrodynamic electron beam manipulator;
the electron beam manipulator is configured for manipulating the electron beam by at least one of the group consisting of focusing the electron beam onto a target section of the anode, positioning the electron beam towards a target section of the anode, and swinging the electron beam along a one dimensional or along a two-dimensional target trajectory on the anode;
the electron beam manipulator comprises an electrostatic focusing unit, particularly at least two spaced annular electrically conductive structures, being shaped and electrically chargable or charged so as to focus the electron beam in the path between the electrically conductive tape and the anode;
the electron beam manipulator comprises a magnetic focusing unit, particularly an annular coil to which coil a drive current is applicable or applied, optionally having an annular ferrit core, being configured so as to focus the electron beam in the path between the electrically conductive tape and the anode;
the electron beam manipulator comprises a magnetic deflection unit having a magnetic ring with at least two, particularly at least four, magnetic protrusions extending from the magnetic ring inwardly, wherein each ring is surrounded by a coil being supplyable or supplied with electric current so as to deflect the electron beam in the path between the electrically conductive tape and the anode in accordance with the applied electric current;
the X-ray tube has a user interface for enabling a user to control operation of the X-ray tube by control commands, wherein the electron beam manipulator is configured for manipulating the shape and/or a position of the electron beam in accordance with a control command received via the user interface;
the X-ray tube has a control unit configured for controlling operation of the X-ray tube by executing predefined control commands, wherein the electron beam manipulator is configured for manipulating the shape and/or a position of the electron beam in accordance with the executed control commands.

12. The X-ray tube according to claim 9, comprising at least one of the following features:
the electron beam emitter is configured for generating an electron beam with an oval, particularly an elliptical, cross section on the anode, and wherein the anode is slanted with regard to a propagation direction of the electron beam so as to generate an X-ray beam with a circular or a rounded square cross section when being exposed to the electron beam;
the X-ray tube comprises an electron acceleration unit configured for applying an acceleration voltage between the electron beam emitter and the anode for accelerating the electron beam;
the electron beam emitter is at a negative potential in a range between 8 kV and 100 kV in relation to the anode;
the anode is a rotatably mounted anode.

13. An X-ray source, comprising:
an X-ray tube according to claim 9;
an X-ray optic for collecting and focussing X-rays generated in the X-ray tube;
an X-ray beam conditioner for conditioning the X-rays after collecting and focussing them by the X-ray optic.

14. A method of generating an electron beam to be directed towards an anode of an X-ray tube for generating an X-ray beam, the method comprising:
supplying an electrically conductive tape with electric energy for emitting the electron beam;
mounting the tape under permanent tension during the generation of the electron beam.
